(19) United States
(12) Patent Application Publication
(10) Pub. No.: US 2017/0253956 A1
(43) Pub. Date: Sep. 7, 2017

(54) COATING LAYER FOR ELECTRONIC DEVICE MANUFACTURING METHOD THEREOF AND ELECTRONIC DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Dong LIANG, Beijing (CN); Kaixuan WANG, Beijing (CN); Wei LI, Beijing (CN); Hongliang YUAN, Beijing (CN); Li MA, Beijing (CN); Yang YOU, Beijing (CN); Xiaojuan WU, Beijing (CN); Huishun CHEN, Beijing (CN); Xiaoqing PENG, Beijing (CN); Yao BI, Beijing (CN); Zijing ZHANG, Beijing (CN); Qi ZHENG, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/351,996

(22) Filed: Nov. 15, 2016

(30) Foreign Application Priority Data
Mar. 4, 2016 (CN) 201610124844.6

(51) Int. Cl. C23C 4/10; B02C 17/18; C23C 4/134

(52) U.S. Cl. CPC C23C 4/10; C23C 4/134; B02C 17/1815

(57) ABSTRACT

A coating layer for electronic device and an electronic device are provided. The coating layer includes a composite of chambersite and a metal.

### TECHNICAL FIELD

Embodiments of the present disclosure relate to a coating layer for electronic device and a manufacturing method thereof, and an electronic device using the same.

### BACKGROUND

Currently, electronic devices, especially mobile phones, are used very frequently. However, bacteria easily breed in the electronic devices due to the appropriate ambient temperatures, which threaten users' health; Also, in different usage environments, electronic devices usually have friction with other mediums, therefore, the housing thereof is required to be provided with higher abrasion resistance; thus an electronic device housing with abrasion resistance and antibacterial property would be significant for the current development and application of the field of electronic device.

### SUMMARY

Embodiments of the present disclosure provide a coating layer for electronic device, wherein the coating layer comprises a composite of chambersite and a metal.

In one embodiment of the present disclosure, for example, the metal comprises a light metal element or an alloy.

In one embodiment of the present disclosure, for example, the coating layer is a chambersite/aluminum composite coating layer, a chambersite/copper composite coating layer or a chambersite/magnalium composite coating layer.

In one embodiment of the present disclosure, for example, the coating layer is formed by spraying precursor powder on a surface of a housing, wherein the precursor powder is formed by powder of the chambersite and powder of the metal.

Embodiments of the present disclosure provide an electronic device, comprising a housing, wherein a surface of the housing is coated with a coating layer which comprises a composite of chambersite and a metal.

In one embodiment of the present disclosure, for example, in the electronic device, the metal comprises a light metal element or an alloy.

In one embodiment of the present disclosure, for example, in the electronic device, the coating layer is a chambersite/aluminum composite coating layer, a chambersite/copper composite coating layer or a chambersite/magnalium composite coating layer.

In one embodiment of the present disclosure, for example, in the electronic device, the coating layer is formed by spraying precursor powder on the surface of the housing, and the precursor powder is formed by powder of the chambersite and powder of the metal.

Embodiments of the present disclosure provide a method for manufacturing a coating layer of electronic device, comprising: spraying precursor powder on a surface of an electronic device housing, and the precursor powder is formed by powder of chambersite and powder of a metal.

In one embodiment of the present disclosure, for example, in the method, the precursor powder is sprayed on the surface of the electronic device housing, and the precursor powder is formed by the powder of chambersite and powder of aluminum.

In one embodiment of the present disclosure, for example, the method further comprises: mixing and grinding the powder of chambersite and the powder of aluminum in nitrogen atmosphere to form the precursor powder; and then the precursor powder is sprayed on the surface of the electronic device housing.

In one embodiment of the present disclosure, for example, in the method, mixing and grinding the powder of chambersite and the powder of aluminum in nitrogen atmosphere to form the precursor powder comprises: mixing submicron powder of chambersite and superfine powder of aluminum in nitrogen atmosphere to form mixed powder, a particle size of the superfine powder of aluminum is from 200 nm to 500 nm; premixing the mixed powder and alcohol mechanically for 20 minutes, wherein the volume ratio of the mixed powder to the alcohol is from 1:0.95 to 1:1.59; mixing powder after the premixing by high-energy ball-milling for 15-20 minutes, a weight ratio of ball to powder is 11:1, a rotate speed is 1,500-2,000 rounds per minute (R/M); cooling powder after the high-energy ball-milling to room temperature in nitrogen atmosphere, and drying in a vacuum drying oven; and grinding powder after the cooling and the drying in nitrogen atmosphere for 10-15 minutes.

In one embodiment of the present disclosure, for example, in the method, a mass fraction of the chambersite in the mixed powder is from 0.5% to 2%.

In one embodiment of the present disclosure, for example, before mixing and grinding the powder of chambersite and the powder of aluminum in nitrogen atmosphere to form the precursor powder, the method may further comprise the operations: high-energy ball-milling the chambersite powder after mineral purification for 50-60 minutes, wherein a weight ratio of ball to powder is 11:1, a rotate speed is 2,000-3,000 R/M; drying the chambersite powder after high-energy ball-milling in the vacuum drying oven for 5-6 hours, at 65-90° C.; and grinding the chambersite powder after drying for 20-25 minutes to obtain a submicron powder of chambersite.

In one embodiment of the present disclosure, for example, in the method, the precursor powder is sprayed on the surface of the housing through a plasma spraying process.

In one embodiment of the present disclosure, for example, in the method, conditions of the plasma spraying process comprise: an operating voltage is 70-80 V; working gas is argon gas of 38-60 Normal Liter Per Minute (NLPM) and hydrogen of 9-12 Normal Liter Per Minute (NLPM); powder feeding rate is 3-9 gram per minute (g/min); a spraying distance is 90-130 mm; a weight percentage of carbon is 1-9%.

In one embodiment of the present disclosure, for example, in the method, the precursor powder is sprayed on the surface of the electronic device housing, and the precursor powder is formed by the powder of chambersite and powder of magnalium, to form a chambersite/magnalium composite coating layer.

In one embodiment of the present disclosure, for example, in the method, the precursor powder is sprayed on the surface of the electronic device housing, and the precursor powder is formed by the powder of chambersite and powder of copper.

In one embodiment of the present disclosure, for example, in the method, the metal comprises a light metal element or an alloy.

In one embodiment of the present disclosure, for example, in the method, the coating layer is a chambersite/aluminum composite coating layer, a chambersite/copper composite coating layer or a chambersite/magnalium composite coating layer.

### BRIEF DESCRIPTION OF THE DRAWINGS

In order to clearly illustrate the technical solution of the embodiments of the disclosure, the drawings of the embodiments will be briefly described in the following, it is obvious that the described drawings are only related to some embodiments of the disclosure and thus are not limitative of the disclosure.

FIG. 1 illustrates a flow diagram of a manufacturing method for chambersite/aluminum composite coating layer which is coated on a surface of a housing of an electronic device according to an embodiment of the present disclosure.

FIG. 2 illustrates a flow diagram of manufacturing method for chambersite/aluminum composite coating layer which is coated on a surface of a housing of an electronic device according to another embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

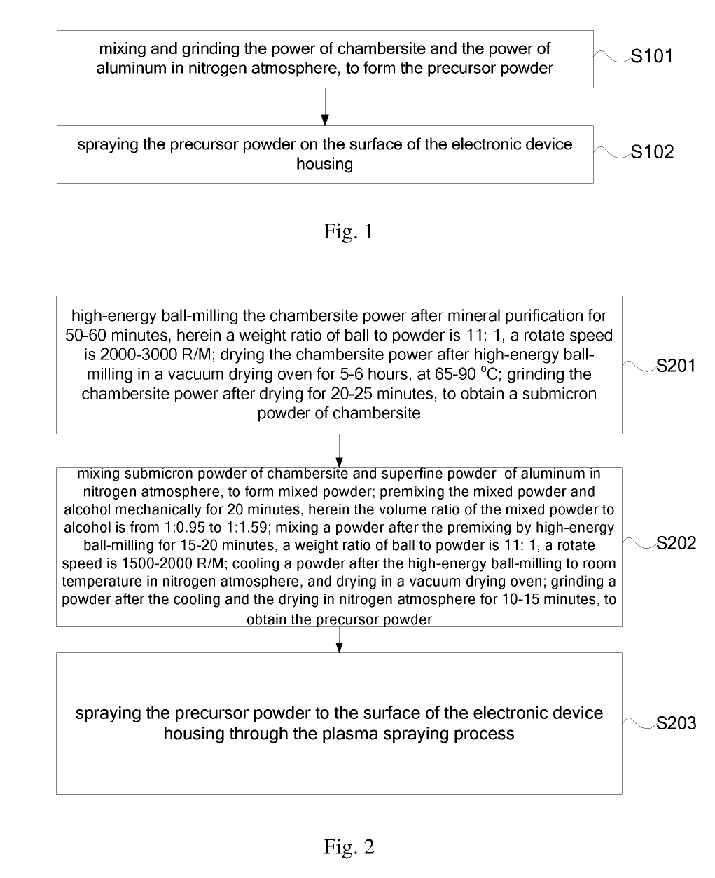

With reference to FIG. 1 and FIG. 2, an embodiment of the present disclosure provides a coating layer for electronic device, and the coating layer is made of a composite of chambersite and metal.

Chambersite is a rare ore, it can be composited with metal to form a chambersite/metal composite coating layer with good bonding strength. Because chambersite has high abrasion resistance and good performances of neutron irradiation, gamma ray irradiation and electromagnetic properties, chambersite/metal composite coating layer both can be abrasion resistant and antibacterial.

An embodiment of the present disclosure provides an electronic device, which comprises a housing, herein, a surface of the housing is coated with a coating layer comprising a composite of chambersite and metal, i.e., a chambersite/metal composite coating layer. At least in some embodiments, the chambersite/metal composite coating layer is formed by spraying precursor powder on the housing, wherein the precursor powder which is made of by powder of the chambersite powder and powder of the metal.

The surface of the above electronic device housing is coated with the chambersite/metal composite coating layer, therefore, the above electronic device housing both can be abrasion resistant and antibacterial.

At least in some embodiments, the chambersite/metal composite coating layer can be a chambersite/aluminum composite coating layer, a chambersite/copper composite coating layer or a chambersite/magnalium composite coating layer; the metal of the chambersite/metal composite coating layer can enhance the bonding strength of the coating layer.

At least in some embodiments, since the coating layer is used for electronic device housing, the metal of the coating layer can be a light metal element or an alloy, for example, the chambersite/metal composite coating layer is a chambersite/aluminum composite coating layer or a chambersite/magnalium composite coating layer.

It should be noted that, the metal of the chambersite/metal composite coating layer is not limited to the above examples.

At least in some embodiments, the chambersite/metal composite coating layer is a chambersite/aluminum composite coating layer, the chambersite/aluminum composite coating layer is formed by spraying precursor powder on the housing, wherein the precursor powder is formed by powder of chambersite and powder of aluminum. The chambersite/aluminum composite coating layer has properties of abrasion resistance and antibacterial, and is more portable; therefore, the electronic device housing is not only abrasion resistant and antibacterial, but also more portable.

An embodiment of the present disclosure further provides an electronic device housing, the surface of the housing is coated with a coating layer comprising a composite of chambersite and metal. The electronic device housing is abrasion resistant and antibacterial, therefore, the electronic device is easy to use and beneficial to human health.

An embodiment of the present disclosure further provides a method for manufacturing a coating layer of the electronic device housing, which comprises:

spraying precursor powder on a surface of the housing, wherein the precursor powder is formed by powder of chambersite and powder of at least one metal, to form a chambersite/metal composite coating layer.

At least in some embodiments, spraying precursor powder on a surface of the housing, wherein the precursor powder is formed by powder of chambersite and powder of at least one metal, to form a chambersite/metal composite coating layer, can be carried out according to one of the following schemes:

In a first scheme, spraying the precursor powder on the surface of the housing, wherein the precursor powder is formed by the powder of chambersite and powder of aluminum, to form a chambersite/aluminum composite coating layer.

In a second scheme, spraying the precursor powder on the surface of the housing, wherein the precursor powder is formed by the powder of chambersite and powder of copper, to form a chambersite/copper composite coating layer.

In a third scheme, spraying the precursor powder on the surface of the housing, wherein the precursor powder is formed by the powder of chambersite and powder of magnalium, to form a chambersite/magnalium composite coating layer.

Surely, the schemes of forming the chambersite/metal composite coating layer are not limited to the above.

At least in some embodiments, as shown in FIG. 1, the above first scheme, i.e. spraying the precursor powder on the surface of the housing, wherein the precursor powder is formed by the powder of chambersite and powder of aluminum, to form a chambersite/aluminum composite coating layer, comprises:

S101, mixing and grinding the powder of chambersite and the powder of aluminum in nitrogen atmosphere, to form the precursor powder;

S102, spraying the precursor powder on the surface of the electronic device housing.

At least in some embodiments, the step S101 may comprise: mixing and grinding submicron powder of chambersite and superfine powder of aluminum in nitrogen atmosphere to form mixed powder, wherein, a particle size of the superfine powder of aluminum is from 200 nm to 500 nm; premixing the mixed powder and alcohol mechanically for 20 minutes, herein the volume ratio of the mixed powder to alcohol is from 1:0.95 to 1:1.59, adding alcohol to premix can prevent the powder overheating during a subsequent ball-milling process and avoid the powder being oxidized; mixing powder after the premixing by high-energy ball-milling for 15-20 minutes, a weight ratio of ball to powder is 11:1, a rotate speed is 1,500-2,000 rounds per minute (R/M); cooling powder after the high-energy ball-milling to room temperature in nitrogen atmosphere, and drying in a vacuum drying oven; grinding a powder after the cooling and the drying in nitrogen atmosphere for 10-15 minutes. For example, the mixed powder contains chambersite with a mass fraction of from 0.5% to 2%.

At least in some embodiments, the precursor powder is sprayed on the surface of the housing by a plasma spraying process.

For example, conditions of the plasma spraying process may comprise: an operating voltage is 70-80 V; working gas is argon gas of 38-60 Normal Liter Per Minute (NLPM) and hydrogen of 9-12 Normal Liter Per Minute (NLPM); powder feeding rate is 3-9 gram per minute (g/min); a spraying distance is 90-130 mm; a carbon adding amount is 1 wt %-9 wt %, that is a weight percentage of carbon is 1%-9%.

At least in some embodiments, before S101, the method further comprises: high-energy ball-milling the chambersite powder after mineral purification for 50-60 minutes, herein a weight ratio of ball to powder is 11:1, a rotate speed is 2000-3000 R/M; drying the chambersite powder after high-energy ball-milling in a vacuum drying oven for 5-6 hours, at 65-90° C.; grinding the chambersite powder after drying for 20-25 minutes, to obtain a submicron powder of chambersite.

At least in some embodiments, as shown in FIG. 2, manufacturing a chambersite/aluminum composite coating layer of the electronic device housing may comprise:

S201, high-energy ball-milling the chambersite powder after mineral purification for 50-60 minutes, herein a weight ratio of ball to powder is 11:1, a rotate speed is 2,000-3,000 R/M; drying the chambersite powder after high-energy ball-milling in a vacuum drying oven for 5-6 hours, at 65-90 ° C.; grinding the chambersite powder after drying for 20-25 minutes, to obtain a submicron powder of chambersite.

S202, mixing submicron powder of chambersite and superfine powder of aluminum (a particle size of the superfine powder of aluminum is from 200 nm to 500 nm) in nitrogen atmosphere, to form a mixed powder; premixing the mixed powder and alcohol mechanically for 20 minutes, herein the volume ratio of the mixed powder to alcohol is from 1:0.95 to 1:1.59; mixing powder after the premixing by high-energy ball-milling for 15-20 minutes, a weight ratio of ball to powder is 11:1, a rotate speed is 1500-2000 R/M; cooling powder after the high-energy ball-milling to room temperature in nitrogen atmosphere, and drying in a vacuum drying oven; grinding powder after the cooling and the drying in nitrogen atmosphere for 10-15 minutes, to obtain the precursor powder;

S203, spraying the precursor powder to the surface of the electronic device housing through the plasma spraying process.

What is described above is related to the illustrative embodiments of the disclosure only and not limitative to the scope of the disclosure; the scopes of the disclosure are defined by the accompanying claims.

The present application claims the priority of Chinese patent application No. 201610124844.6 filed on Mar. 4, 2016, the disclosure of which is hereby incorporated by reference herein in its entirety.

What is claimed is:

1. A coating layer for electronic device, wherein the coating layer comprises a composite of chambersite and a metal.

2. The coating layer according to claim 1, wherein the metal comprises a light metal element or an alloy.

3. The coating layer according to claim 1, wherein the coating layer is a chambersite/aluminum composite coating layer, a chambersite/copper composite coating layer or a chambersite/magnalium composite coating layer.

4. The coating layer according to claim 1, wherein the coating layer is formed by spraying precursor powder on a surface of a housing, and the precursor powder is formed by powder of the chambersite and powder of the metal.

5. An electronic device, comprising: a housing, wherein a surface of the housing is coated with a coating layer which comprises a composite of chambersite and a metal.

6. The electronic device according to claim 5, wherein the metal comprises a light metal element or an alloy.

7. The electronic device according to claim 5, wherein the coating layer is a chambersite/aluminum composite coating layer, a chambersite/copper composite coating layer or a chambersite/magnalium composite coating layer.

8. The electronic device according to claim 5, wherein the coating layer is formed by spraying precursor powder on the surface of the housing, wherein the precursor powder is formed by powder of the chambersite and powder of the metal.

9. A method for manufacturing a coating layer of electronic device, comprising:
spraying precursor powder on a surface of an electronic device housing, wherein the precursor powder is formed by powder of chambersite and powder of a metal.

10. The manufacturing method according to claim 9, wherein the precursor powder is sprayed on the surface of the electronic device housing, and the precursor powder is formed by the powder of chambersite and powder of aluminum.

11. The manufacturing method according to claim 10, further comprising:
mixing and grinding the powder of chambersite and the powder of aluminum in nitrogen atmosphere to form the precursor powder.

12. The manufacturing method according to claim 11, wherein mixing and grinding the powder of chambersite and the powder of aluminum in nitrogen atmosphere to form the precursor powder comprises:
mixing submicron powder of chambersite and superfine powder of aluminum in nitrogen atmosphere to form mixed powder, a particle size of the superfine powder of aluminum is from 200 nm to 500 nm;
premixing the mixed powder and alcohol mechanically for 20 minutes, wherein a volume ratio of the mixed powder to the alcohol is from 1:0.95 to 1:1.59;
mixing the mixed powder after the premixing by high-energy ball-milling for 15-20 minutes, a weight ratio of ball to powder is 11:1, a rotate speed is 1,500-2,000 rounds per minute (R/M);
cooling the mixed powder after the high-energy ball-milling to room temperature in nitrogen atmosphere and drying in a vacuum drying oven; and
grinding the mixed powder after the cooling and the drying in nitrogen atmosphere for 10-15 minutes.

13. The manufacturing method according to claim 12, wherein a mass fraction of the chambersite in the mixed powder is from 0.5% to 2%.

14. The manufacturing method according to claim 11, wherein before mixing and grinding the powder of chambersite and the powder of aluminum in nitrogen atmosphere to form the precursor powder, the method further comprises:
high-energy ball-milling the chambersite powder after mineral purification for 50-60 minutes, wherein a weight ratio of ball to powder is 11:1, a rotate speed is 2,000-3,000 R/M;
drying the chambersite powder after high-energy ball-milling in the vacuum drying oven for 5-6 hours, at 65-90° C.; and
grinding the chambersite powder after drying for 20-25 minutes to obtain a submicron powder of chambersite.

15. The manufacturing method according to claim 9, wherein the precursor powder is sprayed on the surface of the housing through a plasma spraying process.

16. The manufacturing method according to claim 15, wherein, conditions of the plasma spraying process comprise: an operating voltage is 70-80 V; working gas is argon gas of 38-60 Normal Liter Per Minute (NLPM) and hydrogen of 9-12 Normal Liter Per Minute (NLPM); powder feeding rate is 3-9 gram per minute (g/min); a spraying distance is 90-130 mm; a weight percentage of carbon is 1%-9%.

17. The manufacturing method according to claim 9, wherein, the precursor powder is sprayed on the surface of the electronic device housing, and wherein the precursor powder is formed by the powder of chambersite and powder of magnalium, to form a chambersite/magnalium composite coating layer.

18. The manufacturing method according to claim 9, wherein the precursor powder is sprayed on the surface of the electronic device housing, and wherein the precursor powder is formed by the powder of chambersite and powder of copper.

19. The manufacturing method according to claim 9, wherein the metal comprises a light metal element or an alloy.

20. The manufacturing method according to claim 9, wherein the coating layer is a chambersite/aluminum composite coating layer, a chambersite/copper composite coating layer or a chambersite/magnalium composite coating layer.
